(19) United States
(12) Patent Application Publication
(10) Pub. No.: US 2013/0185906 A1
(43) Pub. Date: Jul. 25, 2013

(54) DEVICES, SYSTEMS AND METHODS RELATING TO FALL PROTECTION ANCHORAGE FOR OVER HEAD AND ROOFING INSTALLATION

(71) Applicant: Steven Christopher Nichols, Jr., Duvall, WA (US)

(72) Inventor: Steven Christopher Nichols, Jr., Duvall, WA (US)

(21) Appl. No.: 13/666,796

(22) Filed: Nov. 1, 2012

Related U.S. Application Data
(60) Provisional application No. 61/554,967, filed on Nov. 2, 2011.

(51) Int. Cl. A62B 35/00; B23P 11/00

(52) U.S. Cl. CPC A62B 35/0068; B23P 11/00
USPC 24/703.1; 29/428; 29/592; 29/505

(57) ABSTRACT

Fall protection anchor devices and systems suitable to attach to a retention element of a structure prior to compression rolling of the retention element during manufacture. The system can comprise: a) a fall protection anchor comprising at least two opposed elongate legs connected to each other and forming a self-attachment portion, a capture portion and a distal holding portion wherein the self-attachment portion is configured to attach the two elongate legs to each other and to accept a self-attachment element; the capture portion is configured to capture the retention element for the structure to retain the anchor to the structure; the distal holding portion is distal to the capture portion and is configured to hold a fall-arrest device connected to a worker; and b) at least one self-attachment element configured to attach the self-attachment portions of the two elongate legs to each other; wherein at least one of the elongate legs comprises at least one inward-bent shoulder that is bent toward the opposed elongate leg such that a width of the entire anchor system does not substantially exceed the width of the capture portion of the anchor. Methods of making and using such systems.

### CROSS-REFERENCE TO RELATED APPLICATIONS

The present application claims the benefit of copending U.S. Provisional Patent Application Ser. No. 61/554,967, filed Nov. 2, 2012, which application is incorporated herein by reference in its entirety.

### BACKGROUND

Builders have concerns about safety of workers that are working in areas subject to fall risks, while also being concerns about costs associated with providing such safety.

There has gone unmet a need for improved systems and methods of anchor attachment and reducing costs associated therewith. The present systems and methods, etc., provide these and/or other advantages.

### SUMMARY

Disclosed herein are anchor devices, systems and methods relating to fall protection anchorage for workers building structures such as houses and office buildings involving overhead or roofing installation and other fall-risk areas. The devices, etc., comprise configurations, structures and methods for improved ability to insert or attach the anchors to trusses (or other structure retention elements to which the anchors can be attached and retained) during truss/structure retention element manufacture.

Briefly, truss fabrication utilizes a compression roller to set web component connecting plates of various sizes onto the truss. Connectors in the components are aligned along the same plane or elevation relative to the trusses (i.e., aligned with the upper and lower sides of the truss to be compressed and thus underneath the compression roller) so that they don't “stick up” and cause damage to the compression roller as it rolls over those components and the truss.

Thus, in some specific embodiments the devices, methods and systems herein, provide fall protection anchors and anchor systems suitable for attachment to a retention element of a structure prior to compression rolling of the retention element during manufacture. For example, the systems can comprise:
a) a fall protection anchor comprising at least two opposed elongate legs connected to each other and forming a self-attachment portion, a capture portion and a distal holding portion, wherein:
   the self-attachment portion can be configured to attach the two elongate legs to each other and to accept a self-attachment element;
   the capture portion can be configured to capture a retention element of a structure to retain the anchor to the structure;
   the distal holding portion can be distal to the capture portion and can be configured to hold a fall-arrest device connected to a worker; and
b) at least one self-attachment element configured to attach the self-attachment portions of the two elongate legs to each other; wherein at least one of the elongate legs can comprise at least one inward-bent shoulder that can be bent toward the opposed elongate leg such that a width of the entire anchor system does not substantially exceed the width of the capture portion of the anchor.

The self-attachment portion of the elongate legs can be proximal to the capture portion or within the distal holding portion. Each of the elongate legs of the anchor can be separate pieces of material or unitary. The first leg and the second leg can each comprise an inward-bent shoulder proximal to the capture portion, and the inward-bent shoulder extends inwardly from the capture portion.

The self-attachment element can comprise at least one weld between the opposed elongate legs, or can comprise a bolt and nut. The bolt or the nut can be permanently adhered to one of the elongate legs. The bolt can have a bolt head and one or both the elongate legs can comprise a corresponding threaded bolt hole sized to receive and secure the bolt. The bolt can have a bolt head and a nut, and wherein the bolt head can be set in a bolt-head hole in a first of the elongate legs, the bolt-head hole sized to receive and secure the bolt head such that the bolt head does not twist when the bolt head can be secured in the bolt-head hole. Each elongate leg can comprise a bolt-head hole sized to receive and secure the bolt head.

An internal width of the capture portion can be any desired width, such as (for an 2-by-xx truss) a relatively loose-fitting 1¾″ or instead a tight-fitting 1½″ to 1⅝″, or even a more tight 1⅜″ to 1¼″. The loose fit can allow some rotation of the anchor on the truss while the tight-fit inhibits such rotation.

The system further can comprise the retention element of the structure itself, which retention element can be a truss, or any other suitable anchoring point in the structure, such as a roof beam in an office building.

The system further can comprise a tether attachment element configured to tether the anchor to the retention element, and/or a tell-tale feature configured to indicate that the anchor has been subjected to a fall-arrest-level force load and should not be used again. The tell-tale feature can comprise the holding portion being configured to significantly bend upon being subject to the fall-arrest-level force load. The anchor can be configured to be temporarily or permanently adhered to the retention element.

The holding element can be a hole in the holding portion sized to receive the fall-arrest device. The elongate legs further comprise inwardly directed grippers configured to grip the retention element.

A label such as a warning label can be disposed across the part of the distal holding portion configured to hold the fall-arrest device to provide a tell-tale indicator for whether the anchor has been used previously to hold a fall-arrest device because use of a fall-arrest device with the anchor requires removal or piercing of the label. The can also comprise use of a “blocking” element, e.g., a 24″ length of 2×4 as shown, under a top chord.

In a further aspect, the present discussion includes methods of making a fall protection anchor or anchor system as set forth herein. Such methods can comprise, a providing at least one piece of anchor material; and b) forming the material into an anchor as set forth herein. Such methods can further comprise c) combining the anchor of element b) with a self-attachment element as set forth herein.

The methods further can comprise providing the anchor and the self-attachment elements in a kit. The combining can comprise passing the self-attachment element through the self-attachment portion to attach the two elongate legs to each other.

In another aspect, the present discussion includes methods of using an anchor or anchor system as set forth herein. Such methods can comprise: a) providing the anchor or anchor system as set forth herein, and b) attaching the anchor to a retention element of a structure by enclosing the retention element within the capture portion of the anchor. The methods can further comprise c) attaching the elongate legs of the anchor to each other using the self-attachment element according as set forth herein.

The method further can comprise using the anchor during a manufacture of a structure comprising the retention element. For example, the methods further can comprise:
providing the retention element of the structure prior to compression rolling of the retention element;
enclosing the retention element within the capture portion of the anchor;
attaching the elongate legs of the anchor to each other using the self-attachment element; and then,
compression rolling the retention element, anchor and self-attachment element through a compression roller system without interference of the compression roller system by the anchor or self-attachment element.

The attaching the elongate legs of the anchor to each other can comprise passing the self-attachment element through a hole in the self-attachment portion to attach the two elongate legs to each other. The passing can comprise passing a bolt through a hole in the self-attachment portion and then threading a nut on the bolt. The passing can also comprise permanently attaching the nut or bolt to at least one of the elongate legs and then threading the corresponding bolt or nut onto the other. The attaching the elongate legs of the anchor to each other can also or instead comprise welding the legs to each other within the self-attachment portion of the anchor.

The anchors herein can be used for any suitable anchoring purpose, for example construction such as new and existing wood and steel framed structures requiring fall protection. The anchors are typically used on and attached to roofs but can be attached to any suitable structure strong enough to safely withstand a fall by a worker attached to the anchor.

Typically, the legs are equidistant, but if desired one can be longer than the other either before or after the capture portion. At least one of the legs is bent at an angle relative to the other to decrease the width of the anchor before, and after as appropriate, the capture portion. Such bend forms an inward-bent shoulder (inward relative to the midline of the anchor itself, and therefore generally also inward relative to the midline of a truss captured by the anchor).

The anchors herein can be installed to extend through the roofing membrane of the structure being built leaving a small portion of the roofing unfinished and open to allow the anchor stem to be accessed. When the roofing is completed, the anchor can be evacuated by removing the attachment bolt and hammering the top of the anchor stem down until it is out of the way of other construction, for example until it is flush with the roofing membrane. Evacuated or removed from service includes either or both physically removing the anchor device from the area or rendering the device redundant or inoperable, for example by the hammering down discussed above. Hammering down a device can be advantageous as it is very quick and therefore cost effective while eliminating the anchor from future interference with the roof or other nearby structures. The roofing portion that was left unfinished is then completed.

These and other aspects, features and embodiments are set forth within this application, including the following Detailed Description and attached drawings. Unless expressly stated otherwise, all embodiments, aspects, features, etc., can be mixed and matched, combined and permuted in any desired manner.

### BRIEF DESCRIPTION OF THE FIGURES

FIG. 1 depicts a cut-away plan view of one embodiment of an anchor as discussed herein.

FIG. 2 depicts a multiple front, back and side plan views of embodiments of the anchor as discussed herein.

FIG. 3 depicts a cut-away side plan view of a further embodiment of an anchor as discussed herein comprising a U-shape wherein the carabiner or snaphook of the lanyard of a worker's lifeline also functions as the self-attachment element holding the legs of the anchor to each other.

FIG. 4 depicts side views of embodiments of the anchor and anchor systems herein wherein the anchor has substantially a U-shape and the self-attachment portion is within the distal holding portion.

FIG. 5 depicts a front, side and back plan views of embodiment of anchors wherein the anchor comprises an inwardly-directed flange configured to embed into a side of a retention element.

FIG. 6 depicts a cut-away side plan view of various embodiments of anchors as discussed herein.

### DETAILED DESCRIPTION

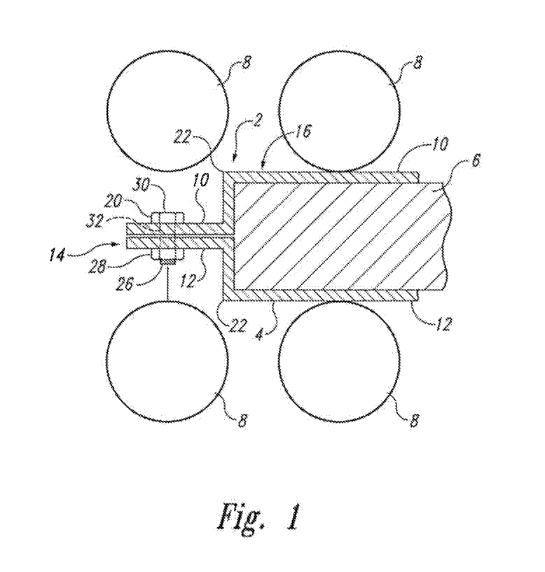

Turning first to the figures, FIG. 1 shows an exemplary fall protection anchor system 2 suitable for attachment to a retention element 6 such as a truss or top chord of a structure such as a house or office building. Fall protection anchor system 2 can be attached to the retention element prior to compression rolling of the retention element 6 during its manufacture. In FIG. 1, compression rollers 8 compress the fall protection anchor system 2, including the fall protection anchor 4 and the retention element 6, during manufacture by squeezing the fall protection anchor system 2 between the compression rollers 8. The compression rollers 8 also attach web components and other elements to the retention element 6, and can join the different pieces of the retention element 6 together to create the truss or other structural element for the house or office, etc.

As shown in FIGS. 1-4 and 6, the fall protection anchor system 2 can comprise:

a) a fall protection anchor 4 comprising at least two opposed elongate legs 10, 12 connected to each other and forming a self-attachment portion 14, a capture portion 16 and a distal holding portion 18, wherein:
the self-attachment portion 14 is configured to attach the two elongate legs 10, 12 to each other and to accept a self-attachment element 20;
the capture portion 16 is configured to capture a retention element 6 of a structure to retain the anchor to the structure;
the distal holding portion 18 is distal to the capture portion 16 and is configured to hold a fall-arrest device 36 connected to a worker; and
   b) at least one self-attachment element 20 configured to attach the self-attachment portions 14 of the two elongate legs 10, 12 to each other; wherein at least one of the elongate legs 10, 12 comprises at least one inward-bent shoulder 22 that is bent toward the opposed elongate leg such that a width of the entire fall protection anchor system 2 does not substantially exceed the width of the capture portion 16 of the anchor. FIG. 1 provides some exemplary widths, and shows that the width of 1.75″ for the combined fall protection anchor 4 and retention element 6 is 1.75″, and thus the width of the self-attachment portion 14 and distal holding portion 18 is less than 1.75″. Other Figures also provide exemplary sizes and dimensions; such sizes and dimensions demonstrate particular embodiments of the systems, devices, etc., herein; other sizes and dimensions can be used as needed. In some embodiments, the fall protection anchors 4 may further comprise self-attachment element(s) 20.

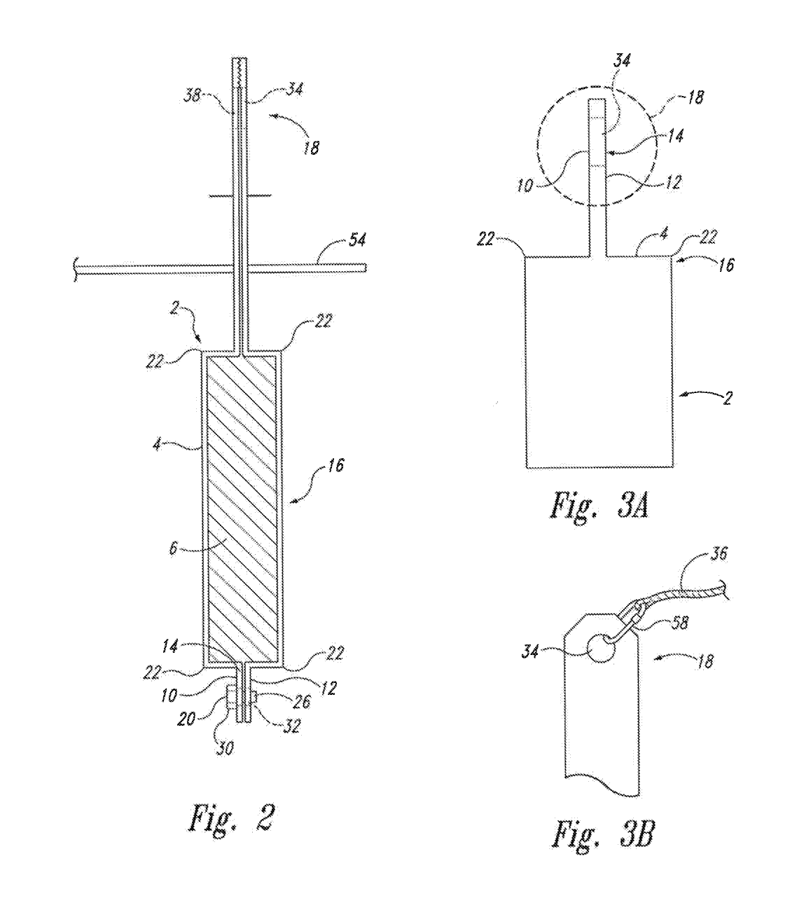

As used herein, “inward-bent” includes bends due to angles, curves, or other geometries that cause an inward-directed shape in the leg(s) of the anchor sufficient to reduce the width of the anchor outside the capture portion 16 such that the self-attachment binding element 20s do not exceed the width of the anchor at the capture portion 16. As used herein, “width” of the anchor refers to the side to side distance of the anchor across the capture portion 16 holding the truss or other retention element 6, for example the width of 1.75″ as indicated in FIG. 1 or other suitable widths such as 1⅝″ (1.625″). “Height” or “length” of the anchor is typically the longest axis of the anchor and indicates distance from the most proximal edge at the bottom of the anchor to the most distal edge of stem the anchor, which is about 14″-16″ in FIG. 2. Breadth refers to the distance across the anchor, for example the breadth of 2″ in FIG. 2.

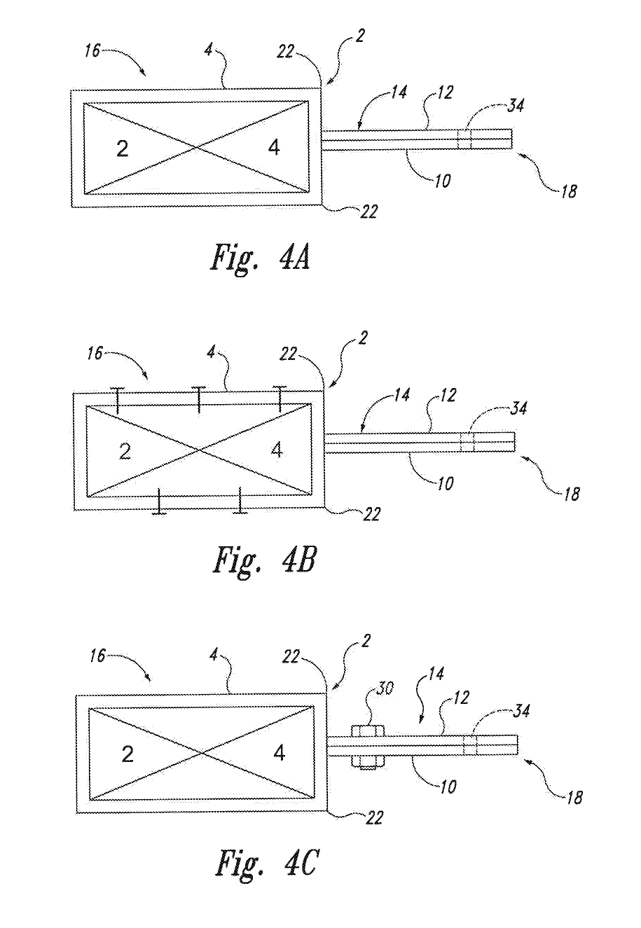

The self-attachment portion 14 of the elongate legs 10, 12 can be proximal to the capture portion 16 or within the distal holding portion 18 as in FIGS. 3-4. Each of the elongate legs 10, 12 of the anchor can be separate pieces of material as in FIGS. 1, 2 and 6, or unitary as in FIGS. 3-5.

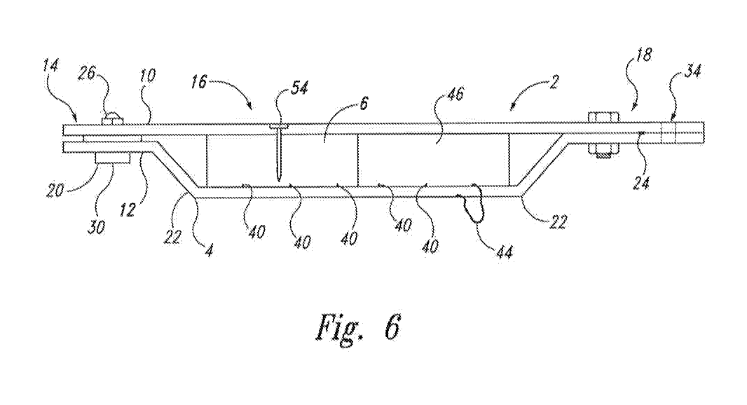

As shown for example in the embodiment shown in FIGS. 1-2, the first elongate leg 10 and the second elongate leg 12 can each comprise an inward-bent shoulder 22 proximal to the capture portion 16, and the inward-bent shoulder 22 extends inwardly from the capture portion 16. In an exemplary alternate embodiment, as shown in FIG. 6, the inward-bent shoulder(s) 22 can be found in just one of the elongate legs.

The self-attachment element 20 can comprise any suitable connector between the opposed elongate legs 10, 12, such as at least one weld 24 as in FIG. 6, or a bolt 26 and nut 28 as in FIG. 1. The bolt 26 or the nut 28 can be permanently adhered to one of the elongate legs 10, 12. The bolt 26 can have a bolt head 30 and one or both the elongate legs 10, 12 can comprise a corresponding threaded bolt hole sized to receive and secure the bolt 26. The bolt head 30 can be set in a bolt-head hole 32 in a first of the elongate legs 10, 12, the bolt-head hole 32 sized to receive and secure the bolt head 30 such that the bolt head 30 does not twist when the bolt head 30 is set in the bolt-head hole 32. Each elongate leg can comprise a bolt-head hole 32 sized to receive and secure the bolt head 30.

An internal width of the capture portion 16 can be any desired width, such as (for a 2-by-xx truss) a relatively loose-fitting 1¾″ or instead a tight-fitting 1½″ to 1⅝″, or even a more tight 1⅜″ to 1¼″. The loose fit can allow some rotation or sliding of the anchor on the truss while the tight-fit inhibits such movement.

FIG. 3B shows a proximal end of a fall-arrest device 36 attached to the holding portion 18 of anchor 4. The safety equipment connectors for fall-arrest devices 36 can be any desired connector, such as carabiner 58 as shown, or cable loops, snap-hooks or rebar hooks.

The fall protection anchor system 2 further can comprise the retention element 6 of the structure itself, which retention element 6 can be a truss, or any other suitable anchoring point in the structure, such as a roof beam in an office building.

The fall protection anchor 4 can be made from any suitable material such as zinc coated steel or stainless steel (SST). The elongate legs 10, 12 can further comprise inwardly directed grippers 40 configured to grip the retention element 6, for example as shown in FIG. 6.

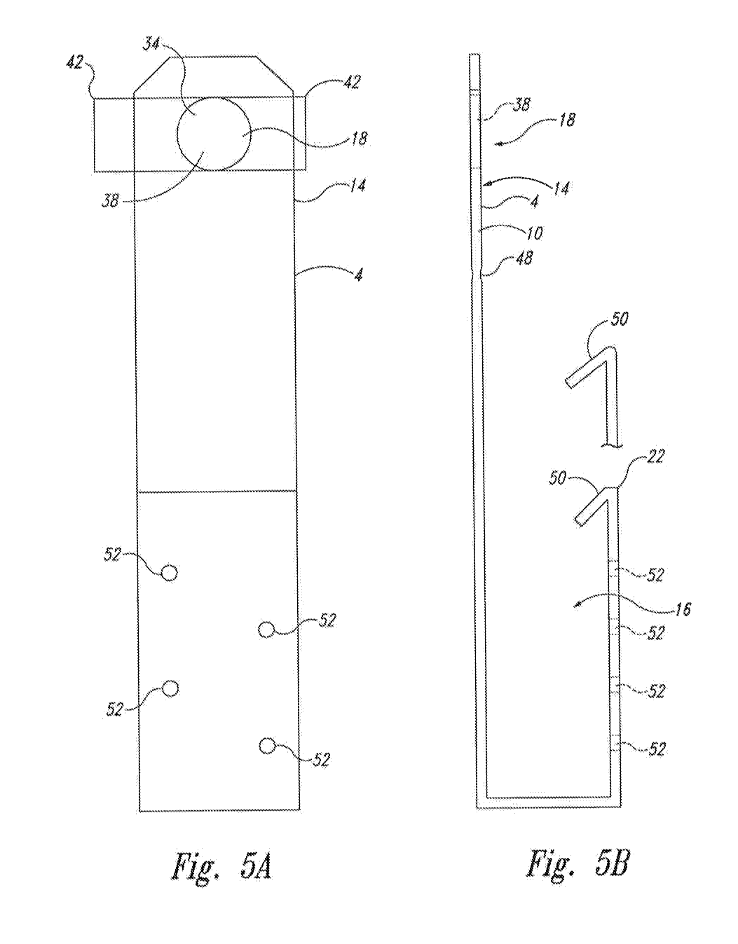

The fall protection anchor system 2 further can comprise, as shown in FIG. 6, a tether 44 configured to tether the anchor to the retention element 6. The fall protection anchor system 2 can also comprise, as shown in FIG. 5, a tell-tale element configured to indicate that the anchor has been subjected to a fall-arrest-level force load and should not be used again. In FIG. 5, the tell-tale element 48 comprises the holding portion 18 being configured to bend at the location pinpointed at tell-tale element 48 upon being subject to the fall-arrest-level force load. Other suitable fall-arrest-load tell-tales can also be used as desired.

The anchor 4 can be configured to be temporarily or permanently adhered to the retention element 6.

As shown for example in FIGS. 2-6, the holding portion 18 comprises a holding element 34 configured to retain a fall-arrest device 36. The holding element 34 can be any suitable structure, such as a fall-arrest device hole 38 in the holding portion 18 sized to receive the fall-arrest device 36.

In FIG. 2, the anchor 4 is extends through the roofing membrane 54 of a structure. This can be accomplished by leaving a small portion of the roofing unfinished and open to allow the stem lifeline-holding hole 38 (in holding element 34) of the anchor 4 to be accessed by workers. Once the roofing is completed, the anchor 4 can be evacuated by removing the attachment bolt 26 and hammering the top of the anchor 4 down until it is out of the way of other construction, for example until it is flush with the roofing membrane. Evacuated or removed from service includes either or both physically removing the anchor device from the area or rendering the device redundant or inoperable, for example by the hammering down discussed above. Hammering down a device can be advantageous as it is very quick and therefore cost effective while eliminating the anchor from future interference with the roof or other nearby structures. The roofing portion that was left unfinished is then completed.

As shown in FIG. 5 a label 42 such as a warning label can be disposed across the part of the distal holding portion 18 configured to hold the fall-arrest device 36. As shown, a fall-arrest device hole 38 has label 42 placed across it. This label 42 provides a tell-tale indicator whether the anchor has been used previously to hold a fall-arrest device 36 because use of a fall-arrest device 36 with the anchor requires removal or piercing of the label 42. The warning label 42 can also advise potential users to be careful to assure that adequate bracing is in place before using the anchor.

In FIG. 5, the fall protection anchor 4 and systems 2 can comprise at least two opposed elongate legs 10, 12 connected to each other to form a capture portion 16 configured to capture a retention element and a distal holding portion 18 configured to hold a fall-arrest device connectable to a worker. In this embodiment, a first of the elongate legs 10 comprises the distal holding portion and a second of the elongate legs 12 is shorter than the first elongate leg and comprises a flange 50 angled inwardly to hold the retention element, for example angled from more 90° to less than 180°. The flange 50 can be embeddable into a side of the retention element upon capture of the retention element by the anchor.

As also shown in FIG. 5, but also suitable for other configurations of anchor 4, the anchor 4 can comprise nail holes 52 configured to accept nails or other to attach the anchor to the retention element.

In the embodiment shown in FIG. 6, a representative nail 54 is shown attaching the anchor 4 and the retention element 6. FIG. 6 also depicts use of “blocking 46”, e.g., a 24″ length of 2×4 as shown, under or adjacent the top chord. The blocking 46 and the top chord can be encapsulated together by the fall protection anchor 4 for increased strength. The 2×4 blocking 46 disperses the load over the top chord and widens the pressure point created by the anchor attachment bolt 26 and anchor stem shoulders 22. As shown, the 2×4 blocking 46 is attached to the top chord using connector plates, which plates can be affixed to the top chord and blocking 46 by the compression rollers.

In a further aspect, the present discussion includes methods of making a fall protection anchors or fall protection anchor systems as discussed herein. Such methods can comprise, for example, providing at least one piece of anchor material; and b) forming the material into a fall protection anchor as discussed herein. Such methods can further comprise c) combining the fall protection anchor of element b) with a self-attachment element as discussed herein. The combining can comprise passing the self-attachment element through the self-attachment portion to attach the two elongate legs, to each other.

The methods further can comprise providing the fall protection anchors and the self-attachment elements in a kit. Other elements of the systems discussed herein, as well as other desired devices, can also be provided in the kit.

In another aspect, the present discussion includes methods of using an anchor or fall protection anchor system as discussed herein. Such methods can comprise: a) providing the fall protection anchors or fall protection anchor systems as discussed herein, and b) attaching the fall protection anchors to a retention element of a structure by enclosing within or otherwise attaching the retention element to the capture portion of the fall protection anchors. The methods can further comprise c) attaching the elongate legs, of the anchor to each other using the self-attachment element according as discussed herein.

The methods further can comprise using the anchor during a manufacture of a structure comprising the retention element. For example, the methods further can comprise:
providing the retention element of the structure prior to compression rolling of the retention element;
enclosing the retention element within the capture portion of the anchor;
attaching the elongate legs, of the anchor to each other using the self-attachment element; and then,
compression rolling the retention element, anchor and self-attachment element through a compression roller system without interference of the compression roller system by the anchor or self-attachment element.

The attaching the elongate legs, of the anchor to each other can comprise passing the self-attachment element through a fall-arrest device hole in the self-attachment portion to attach the two elongate legs, to each other. The passing can comprise passing a bolt through a fall-arrest device hole 3 in the self-attachment portion and then threading a nut on the bolt. The passing can also comprise permanently attaching the nut or bolt to at least one of the elongate legs, and then threading the corresponding bolt or nut onto the other. The attaching the elongate legs, of the anchor to each other can also or instead comprise welding the legs, to each other within the self-attachment portion of the anchor.

The attaching the elongate legs, of the anchor to each other can further comprise passing a bolt through a fall-arrest device hole in the self-attachment portion and then threading a nut on the bolt.

The attaching the anchor to the structure can be effected solely by compressing the self-attachment portions to each other by compression rolling the retention element, anchor and self-attachment element through a compression roller system.

The methods can further can comprise tethering the anchor to the retention element of the structure, and removing the anchor from the retention element of the structure if desired. The methods can also further can comprise subjecting the anchor to a fall-restraint-level force load or fall-arrest-level force load, including bending the distal holding portion of the anchor due to force of the fall-arrest-level force load to provide a tell-tale indicating that a fall-arrest-level force load has been applied to the anchor.

Turning to a general discussion of certain embodiments of the systems, devices, etc., herein, the anchors herein can be used for any suitable anchoring purpose, for example construction such as new and existing wood and steel framed structures requiring fall protection. The anchors are typically used on and attached to roofs but can be attached to any suitable structure strong enough to safely withstand a fall by a worker attached to the anchor.

The anchors can be produced in any desired configuration provided they comprise the elements discussed herein. Exemplary models include:
1) A temporary fall protection anchorage device configured to attach to softer structures such as wood or steel framed structures (or other materials such as plastics or other metals), for example at top chords of trusses or rafters. This temporary fall protection anchorage device is designed for easy removal and can be made from any suitable material such as zinc coated steel or stainless steel (SST).
2) A permanent fall protection anchorage device made from a suitable long-lasting material such as SST. This device is configured so that it can be installed in an inverted position, if desired, for example to be used as an anchorage device in attics or confined spaces, as an overhead anchorage device, or flashed into the roofing membrane.
3) A permanent fall protection anchorage device configured to utilize a flashing system. This device is typically integral to the roofing membrane and features a design that allows the anchor to be evacuated if desired.

The removable anchors can comprise a generally rectangular or oval shape, as demonstrated in the exemplary figures included herewith, although other shapes such as generally triangular are also possible. Exemplary dimensions of the anchors include about 12″-20″ length and 1.5-3″width, such as a 1½″ or 1⅝″, and about 1½″-3″ in breadth.

Typically, the elongated legs are equidistant, but if desired one can be longer than the other either before or after the capture portion. At least one of the elongated legs is bent at an angle relative to the other to decrease the width of the anchor before, and after as appropriate, the capture portion. Such bend forms an inward-bent shoulder (inward relative to the midline of the anchor itself, and therefore generally also inward relative to the midline of a truss captured by the anchor).

The two elongated legs are joined together at the self-attachment portion using any suitable self-attachment binding element, for example a ¼″, 5/16″, ½″, 7/16″ or ¾″ bolt such as a grade 8 or SST bolt and lock nut. If desired, at least one of the elements of the self-attachment binding element can be permanently fastened to—or even formed in—one of the elongated legs. For example, the nut can be welded or glued to the elongated leg and the bolt can then be passed through the opposed elongated leg then threaded into the nut—or vice-versa. Similarly, for example, the hole receiving the bolt in the elongate elongated leg can be threaded to receive and hold the bolt. Any suitable self-attachment binding element can be used, including for example welding or gluing the two elongate elongated legs to each other, provided that the self-attachment binding element provides adequate strength and stability such that the safety provided by the fall protection anchor is not compromised or weakened.

The two elongated legs comprise at least one capture portion configured to create a capture area and thus to capture a retention element such as a top chord to hold the anchor to a structure. The finished installation of the anchor captures (e.g., fully or substantially envelopes or wraps around) the top chord, preferably without use of any bolt, screws, nails or other fastening elements penetrating through the chord (structure retention element). Thus, this device can be much stronger and more dependable than traditional surface mounted devices and can withstand over 3600 or 5000 lbs. of force or more when subjected to static pull testing yet does not compromise the integrity or strength of the chord. If desired, the anchor can be configured to be either permanently attached to the truss or chord, or the anchor can be configure to be easily removed from or moved along the chord.

At least one elongated leg of the anchor device comprises a holding portion, typically distal to the capture area, that holds a fall-arrest device 36 attached to the worker. The holding portion can comprise an opening or other capture device to receive or grab onto safety equipment connectors for fall-arrest devices, such as cable loops, snap-hooks, carabiners or rebar hooks. If the capture device is an opening, the opening can be about 1⅛″ in diameter. If desired, both elongated legs of the anchor can extend well beyond the capture area of the anchor, and can be substantially co-extensive. In such a case, both anchors can have a holding portion such as a hole that traverses both elongated legs in corresponding locations to effectively provide a single hole.

The anchor can be installed from the either underside or topside of a top chord or truss or other retention element.

In certain embodiments, the anchors can be attached through a sheath such as a roofing membrane in addition to the chord, and sheathing penetration for the stem (distal portions of the elongated legs) of the anchor can be planned in advance. For example, suitable approaches can be a square opening (e.g., 2.5″×2.5″) in the sheath or saw kerfs (e.g., ⅛″×2.5″) for the anchor elongated legs at the sheathing edges.

The current anchor devices can comprise an easy evacuation feature: simply undo the self-attachment binding element and remove it from the retention element of the structure, or hammer it down and out of the way.

The anchors herein can be installed to extend through the roofing membrane leaving a small portion of the roofing unfinished and open to allow the anchor stem to be accessed. Once the roofing is completed, the anchor can be evacuated by removing the attachment bolt and hammering the top of the anchor stem down until it is out of the way of other construction, for example until it is flush with the roofing membrane. Evacuated or removed from service includes either or both physically removing the anchor device from the area or rendering the device redundant or inoperable, for example by the hammering down discussed herein. Hammering down a device can be advantageous as it is very quick and therefore cost effective while eliminating the anchor from future interference with the roof or other nearby structures. The roofing portion that was left unfinished is then completed.

The anchors herein may desirably remain accessible for the entire construction period to provide protection for multiples trades (workers). Thus, the final evacuation may not occur until the structure is completed.

The anchors herein can provide improved security features. The evacuation/removal of prior anchors can result in the prior anchors falling from the cord to the interior ceiling and damaging a finished structure. Therefore, in some embodiments the anchors herein further comprise enhanced safety via at least one of: 1) if the anchor herein is hammered down, the triangle design produces its maximum compression once it is driven below the finished roofing membrane and will hold a static position onto the top chord (or other support structure), and/or 2) the anchors herein can be fitted with a failsafe tether that has one end attached to the anchor, for example through a drilled hole in one anchor elongated leg, and a fastener tab on the end of the tether that is secured to the top chord, for example with a nail or screw. Typically, the tether is engineered to support at least 25 times the weight of the anchor device, which anchor can be less than one (1) pound.

The anchors herein can provide improved shock absorbing features. The anchor stem that securely holds the fall-arrest device 36 connected to a worker can be subjected to a significant force when a fall occurs. To account for such a load, whether up or down slope on the top chord, the anchor stem has significant deflection resistance, for example 160-250 lbs. Thus, in the event of a fall, the stem of the anchor will absorb some of the force of the fall.

The anchors herein can provide a tell-tale element, which can be correlated to the deflection of the anchor stem in the event of a fall-arrest-level force load: the anchor stem deflection is used to as a warning device to users who are required to inspect before each use. If the stem is bent, the worker is alerted that the anchor has been subjected to a fall-arrest-level force load and must not be used until it is replaced.

The anchors herein can provide improved resistance to position movement: anchors that encapsulate top chords (or other attachment structure) are prevented from movement by the encapsulating and compressing the chord. Such improved resistance can also include use of grippers on the inside of the capture portion of the anchor, where such grippers are short projections extending inwardly from the inside surface of the one or more of the anchor elongated legs. If desired, the projections can be pressed into the retention element (e.g., truss) during compression rolling of the retention element. The anchors can be further secured in place using suitable fasteners such as nails or screws, or by drilling through the top chord and securing with a bolt, if desired.

The anchors herein are configured to fully or substantially envelop (wrap around) the support structure such as a top chord of a roof. In certain embodiments, the anchors can rotate on the top chord and include a base plate that creates a gripping action when the anchor is subjected to an upslope or downslope force load. Such “free-swinging” use, typically on an overhead support structure, will not produce the unmoving gripping effect that occurs when the anchor stem is installed onto the top chord of a house (or other usage site) in its compressed position as described for other embodiments herein.

The anchors herein can be used both in open spaces such as the roof of a house as well as enclosed spaces such as inside an attic or crawl space where fall protection is required for workers installing HVAC, insulation, wiring, etc. in attic spaces that have a dangerous elevation above a floor or lower level (e.g., more than six (6) feet above the lower level or floor). Note: Finished ceilings do not provide protection against a falling worker striking a lower level: if a worker in the attic falls, he or she can plunge through the ceiling wall board to the floor below. When used in an interior space, or otherwise as may be desired, the anchors can be utilized in the inverted position as an overhead anchorage device.

The anchors herein can have an additional mechanical fastener that extends to or through the base plate to the underlying support structure (e.g., the chord) as a further precaution against movement in the event that a fall occurs prior to sheathing being installed over it. For example, the fastening can be achieved by two offset holes in the base plate that allow a suitable fastener such as a 16 d nail or equal screw.

In some embodiments, the devices herein are created of a unitary piece of steel (or other suitable material) and can be installed using a single bolt (or other suitable fastening mechanism). This can eliminate the need to drill through the top chord/support structure because the anchor envelops the top chord instead of being “plugged” into it. Further, the wrap-around design encapsulates the top cord, which cord provides excellent strength to withstand free-fall forces (e.g., 1800-2500+ lbs.).

The removable or permanent anchors herein can be manufactured and used at a lower unit cost than the traditional anchors presently used, even though the anchors herein can attach to the same types of support structures and locations on such support structures as the traditional anchors. The new anchors can also be used with support structures/locations beyond those of the traditional anchors.

Also as with the other anchors and anchor systems herein, methods of making and using such anchors and systems are included herein, including forming or fabricating the anchors and systems, using the systems with retention members, using the anchors with workers attached by fall-arrest harnesses and lines to the anchors, securing the elongated legs of the anchors to themselves using the lifeline attachment element such as a snaphook, carabiner, etc., and/or embedding the flange into the retention element. In addition, the methods further can comprise providing a blocking 46 element operably connected to the retention element, the blocking 46 element configured to strengthen the retention element captured by the capture portion, and then attaching anchor to the retention element of the structure.

All terms used herein are used in accordance with their ordinary meanings unless the context or definition clearly indicates otherwise. Also unless expressly indicated otherwise, in the specification the use of “or” includes “and” and vice-versa. Non-limiting terms are not to be construed as limiting unless expressly stated, or the context clearly indicates, otherwise (for example, “including,” “having,” and “comprising” typically indicate “including without limitation”). Singular forms, including in the claims, such as “a,” “an,” and “the” include the plural reference unless expressly stated, or the context clearly indicates, otherwise.

The scope of the present devices, systems and methods, etc., includes both means plus function and step plus function concepts. However, the claims are not to be interpreted as indicating a “means plus function” relationship unless the word “means” is specifically recited in a claim, and are to be interpreted as indicating a “means plus function” relationship where the word “means” is specifically recited in a claim. Similarly, the claims are not to be interpreted as indicating a “step plus function” relationship unless the word “step” is specifically recited in a claim, and are to be interpreted as indicating a “step plus function” relationship where the word “step” is specifically recited in a claim.

From the foregoing, it will be appreciated that, although specific embodiments have been discussed herein for purposes of illustration, various modifications may be made without deviating from the spirit and scope of the discussion herein. Accordingly, the systems and methods, etc., include such modifications as well as all permutations and combinations of the subject matter set forth herein and are not limited except as by the appended claims or other claim having adequate support in the discussion and figures herein.

1. A fall protection anchor system suitable for attachment to a retention element for a structure prior to compression rolling of the retention element during manufacture of the retention element, the system comprising:
a) a fall protection anchor comprising at least two opposed elongate legs connected to each other and forming a self-attachment portion, a capture portion and a distal holding portion, wherein:
the self-attachment portion is configured to attach the two elongate legs to each other and to accept a self-attachment element;
the capture portion is configured to capture a retention element of a structure to retain the anchor to the structure;
the distal holding portion is distal to the capture portion and is configured to hold a fall-arrest device connected to a worker; and
b) at least one self-attachment element configured to attach the self-attachment portions of the two elongate legs to each other;
wherein at least one of the elongate legs comprises at least one inward-bent shoulder that is bent toward the opposed elongate leg such that a width of the entire anchor system does not substantially exceed the width of the capture portion of the anchor.

2. The fall protection anchor system of claim 1 wherein the self-attachment portion of the elongate legs is proximal to the capture portion.

3. The fall protection anchor system of claim 1 wherein the self-attachment portion is within the distal holding portion.

4. The fall protection anchor system of claim 1 wherein each of the elongate legs of the anchor are separate pieces of material.

5. The fall protection anchor system of claim 1 wherein the anchor is a unitary piece of material.

6. The fall protection anchor system of claim 1 wherein the first leg and the second leg each comprise an inward-bent shoulder proximal to the capture portion.

7. The fall protection anchor system of claim 1 wherein the inward-bent shoulder extends inwardly from the capture portion.

8. The fall protection anchor system of claim 1 wherein the self-attachment element comprises at least one weld between the opposed elongate legs.

9. The fall protection anchor system of claim 1 wherein the self-attachment element comprises a bolt and nut.

10. The fall protection anchor system of claim 9 wherein at least one of the bolt or the nut is permanently adhered to one of the elongate legs.

11. The fall protection anchor system of claim 1 wherein the self-attachment element comprises a bolt having a bolt head and the elongate leg opposed to the bolt head comprises a corresponding threaded bolt hole sized to receive and secure the bolt.

12. The fall protection anchor system of claim 11 wherein each of the elongate legs comprises corresponding threaded bolt holes sized to receive and secure the bolt.

13. The fall protection anchor system of claim 1 wherein the self-attachment element comprises a bolt having a bolt head and a nut, and wherein the bolt head is set in a bolt-head hole in a first of the elongate legs, the bolt-head hole sized to receive and secure the bolt head such that the bolt head does not twist when the bolt head is secured in the bolt-head hole.

14. The fall protection anchor system of claim 11 wherein each elongate leg comprises a bolt-head hole sized to receive and secure the bolt head.

15. The fall protection anchor system of claim 1 wherein an internal width of the capture portion is 1¼″ to 1⅝″.

16. The fall protection anchor system of claim 1 wherein an internal width of the capture portion is 1¾″.

17. The fall protection anchor system of claim 1 wherein the system further comprises the retention element of the structure.

18. The fall protection anchor system of claim 17 wherein the retention element is a truss.

19. The fall protection anchor system of claim 1 wherein the anchor is made from zinc coated steel or stainless steel (SST).

20. The fall protection anchor system of claim 1 wherein the system further comprises a tether attachment element configured to tether the anchor to the retention element.

21. The fall protection anchor system of claim 1 wherein anchor comprises a tell-tale feature configured to indicate that the anchor has been subjected to a fall-arrest-level force load and should not be used again.

22. The fall protection anchor system of claim 21 wherein the tell-tale feature comprises the holding portion being configured to significantly bend upon being subject to the fall-arrest-level force load.

23. The fall protection anchor system of claim 1 wherein the anchor is configured to be temporarily adhered to the retention element.

24. The fall protection anchor system of claim 1 wherein the anchor is configured to be permanently adhered to the retention element.

25. The fall protection anchor system of claim 1 wherein the holding element is a fall-arrest device hole in the holding portion sized to receive the fall-arrest device.

26. The fall protection anchor system of claim 1 wherein the elongate legs further comprise inwardly directed grippers configured to grip the retention element.

27. The fall protection anchor system of claim 1 wherein the system further comprises a label across a part of the distal holding portion configured to hold the fall-arrest device.

28. The fall protection anchor system of claim 27 wherein the part of the distal holding portion configured to hold the fall-arrest device is a fall-arrest device hole.

29. The fall protection anchor system of claim 1 wherein the system further comprises the retention element of the structure and a blocking element connected to the retention element, the blocking element configured to strengthen the retention element captured by the capture portion.

30. The fall protection anchor system of claim 29 wherein the retention element is a truss.

31. A method of making a fall protection anchor system according to claim 1 comprising:
a) providing at least one piece of anchor material;
b) forming the material into an anchor comprising the elements of an anchor according to claim 1; and,
c) combining the anchor of element b) with a self-attachment element comprising the elements of self-attachment element according to claim 1.

32-49. (canceled)

50. A fall protection anchor suitable for attachment to a retention element of a structure prior to compression rolling of the retention element during manufacture, the system comprising:
a fall protection anchor comprising at least two opposed elongate legs connected to each other and forming a self-attachment portion, a capture portion and a distal holding portion, wherein:
the self-attachment portion is configured to attach the two elongate legs to each other and to accept a self-attachment element;
the capture portion is configured to capture a retention element of a structure to retain the anchor to the structure;
the distal holding portion is distal to the capture portion and is configured to hold a fall-arrest device connected to a worker; and
wherein at least one of the elongate legs comprises at least one inward-bent shoulder that is bent toward the opposed elongate leg such that a width of the entire anchor does not substantially exceed the width of the capture portion of the anchor.

51-75. (canceled)

76. A method of making a fall protection anchor according to claim 50 comprising:
a) providing at least one piece of anchor material;
b) forming the material into an anchor comprising the elements of an anchor according to claim 50.

77. A method of using an anchor according to claim 50 comprising:
a) providing the anchor according to claim 50, and
b) attaching the anchor to a retention element of a structure by enclosing the retention element within the capture portion of the anchor; and
c) attaching the elongate legs of the anchor to each other using a self-attachment element according to claim 1.

78-89. (canceled)

90. A fall protection anchor suitable for attachment to a retention element of a structure comprising at least two opposed elongate legs connected to each other and forming a capture portion configured to capture the retention element and a distal holding portion configured to hold a fall-arrest device connectable to a worker, wherein a first of the elongate legs comprises the distal holding portion and a second of the elongate legs is shorter than the first elongate leg and comprises a flange angled inwardly between at least about 90° to no more than about 180°, such that the flange is embeddable into a side of the retention element upon capture of the retention element by the anchor.

91-94. (canceled)

95. A method of making a fall protection anchor system according to claim 90 comprising:
a) providing at least one piece of anchor material; and,
b) forming the material into an anchor comprising the elements of an anchor according to claim 90.

96-97. (canceled)

98. A method of using an anchor according to claim 90 comprising:
a) providing the anchor according to claim 90, and
b) attaching the anchor to a retention element of a structure by enclosing the retention element within the capture portion of the anchor; and
c) embedding the flange into the retention element.

99. (canceled)

100. A fall protection anchor system comprising a) a fall protection anchor configured for attachment to a retention element of a structure and comprising at least two opposed elongate legs connected to each other and forming a capture portion configured to capture the retention element and a distal holding portion configured to hold a lifeline attachment element of a fall-arrest device connectable to a worker, and b) the lifeline attachment element, and wherein the lifeline attachment element forms substantially the only self-attachment element holding the at least two opposed elongate legs of the anchor to each other.

101-103. (canceled)

104. A method of making a fall protection anchor system according to claim 100 comprising:
a) providing at least one piece of anchor material; and,
b) forming the material into an anchor comprising the elements of an anchor according to claim 100; and
c) providing the lifeline attachment element.

105-106. (canceled)

107. A method of using an anchor according to claim 100 comprising:
a) providing the anchor according to claim 100, and
b) attaching the anchor to a retention element of a structure by enclosing the retention element within the capture portion of the anchor; and
c) attaching a lifeline attachment element to the distal holding portion of the anchor and thereby self-attaching the at least two opposed elongate legs connected to each other.

108-109. (canceled)

110. A fall protection anchor system comprising a) a overhead structure retention element configured for an overhead space of a structure; b) a fall protection anchor attached to the overhead retention element and comprising at least two opposed elongate legs connected to each other and forming a capture portion holding the retention element and a distal holding portion configured to hold a lifeline attachment element of a fall-arrest device connectable to a worker.

111-114. (canceled)

115. A method of making a fall protection anchor system comprising:
a) providing at least one overhead structure retention element configured for an overhead space of a structure; and,
b) providing at least one fall protection anchor comprising at least two opposed elongate legs connected to each other and forming a capture portion configured to hold the overhead retention element and a distal holding portion configured to hold a lifeline attachment element of a fall-arrest device connectable to a worker;
c) putting the fall protection anchor on the at least one overhead structure retention element;
d) compression rolling the fall protection anchor and the overhead structure retention element during manufacture of the overhead structure retention element.

116-120. (canceled)

121. A method of using a combined fall protection anchor and the overhead structure retention element according to claim 110 comprising:
a) providing the combined fall protection anchor and the overhead structure retention element, and
b) attaching a lifeline attachment element to the distal holding portion of the anchor.

122-124. (canceled)
